(19) United States
(12) Patent Application Publication
(10) Pub. No.: US 2016/0184935 A1
(43) Pub. Date: Jun. 30, 2016

(54) BRAZING MATERIAL

(71) Applicant: ALFA LAVAL CORPORATE AB, Lund (SE)

(72) Inventor: Per Sjödin, Lund (SE)

(73) Assignee: ALFA LAVAL CORPORATE AB, Lund (SE)

(21) Appl. No.: 15/062,737

(22) Filed: Mar. 7, 2016

Related U.S. Application Data
(63) Continuation-in-part of application No. 12/515,063, filed on Nov. 17, 2009, now abandoned.

(30) Foreign Application Priority Data
Nov. 17, 2006 (SE) 0602467-3

(51) Int. Cl. B23K 35/30; B23K 1/19; C22C 38/58; F28D 9/00; C22C 38/44; C22C 38/34; C22C 38/00; B23K 1/00; C22C 38/54

(52) U.S. Cl. CPC B23K 35/3066; B23K 1/0012; B23K 1/19; B23K 35/3086; C22C 38/58; C22C 38/54; C22C 38/44; C22C 38/34; C22C 38/002; F28D 9/00

(57) ABSTRACT

Disclosed is a brazing material comprising an alloy containing essentially: (i) 15 to 30 wt % chromium (Cr); 0.1 to 5.0 wt % manganese (Mn); 9 to 20 wt % nickel (Ni); 0 to 4.0 wt % molybdenum (Mo); 0 to 1.0 wt % nitrogen (N); 1.0 to 7.0 wt % silicon (Si); 0 to 0.2 wt % boron (B); 1.0 to 7.0 wt % phosphorous (P); optionally 0.0 to 2.5 wt % of each of one or more of elements selected from the group consisting of vanadium (V), titanium (Ti), tungsten (W), aluminum (Al), niobium (Nb), hafnium (Hf) and tantalum (Ta); the alloy being balanced with Fe, and small inevitable amounts of contaminating elements; and wherein Si and P are in amounts effective to lower melting temperature. Further disclosed is a method of brazing and a product brazed with the brazing material.

### CROSS-REFERENCE TO RELATED APPLICATIONS

This application is a Continuation-in-part application of U.S. patent application Ser. No. 12/515,063, filed with the United States Patent and Trademark Office on May 15, 2009 as a U.S. National Stage Application under 35 U.S.C Section 371 (receiving a Section 371(c) date of Nov. 17, 2009) based upon PCT/SE2007/001011, filed on Nov. 17, 2009, and claiming priority to SE 0602467-3, filed Nov. 17, 2006; the contents of each of the foregoing applications of which are incorporated by reference in their entireties and the benefits of each are fully claimed herein.

### FIELD OF THE INVENTION

The present invention relates to a brazing material, a method of brazing, a product brazed with the brazing material.

### BACKGROUND OF THE INVENTION

Objects of different steel materials or iron-based alloy materials are usually assembled by brazing or soldering with Nickel-based or Copper-based brazing materials. Hereinafter the term brazing is used, but it should be understood that the term also comprises soldering. Brazing is a process for joining parts of metals, but brazing can also be used for sealing objects or coating objects. The brazing temperature is below the original solidus temperature of the base material. During brazing of materials, the brazing material is completely or partly melted during the heat treatment.

Traditional brazing of iron-based materials is performed by Nickel-based or Copper-based brazing materials, and these brazing materials can cause corrosion, for example, due to differences in electrode potential. The corrosion problem will be enhanced when the brazed object is exposed to a chemically aggressive environment. The use of Nickel-based or Copper-based brazing material can also be limited in a number of food applications due to regulations.

One problem is the melting temperature range of the coating or brazing materials. When selecting a brazing material or a coating material, considerations are based on the solidus or liquidus temperatures of the alloy and the base material. Lately, iron-based brazing materials have been developed for brazing objects of traditional stainless steel. These iron-based brazing materials are functioning quite well, but when the temperature range for brazing is broad, then there are risks for defects to occur in the obtained products. A clean element has a sharp melting point, but an alloy contains many different elements in each defined alloy and has therefore often a broad melting interval.

When developing brazing materials there are a lot of properties of importance. One of those is the brazing temperature. A high brazing temperature is quite often associated with high mechanical strength or other properties that are of importance for the braze joint, but it also has some disadvantages. A high temperature may decrease the properties of the base material, by e.g. grain growth, formation of phases in the material, a large impact from the braze filler into the base material by diffusion of elements from the filler to the base material and other changes of the properties of the base material. A high temperature may also increase the risk of erosion of the base material. Costs are also associated with high temperature since there is a need for more energy input and more expensive furnaces. The high temperatures also wear the furnace more, which increases the cost. A normal way when developing a Fe-based brazing material is using Si and/or B as melting point depressants. Boron has a quite large impact of the melting point but has a lot of disadvantages, such as it easily forms chromium borides. Therefore, it is of great importance not to use too much boron. The formation of chromium borides decreases the amount of Chromium in the base material, which then e.g. decreases the corrosion resistance and other properties of the base material. Therefore, when chromium is one of the elements of the alloy, then no or very small amounts of boron are generally the best choice. Silicon is also used to decrease the melting point; however, silicon itself, as a melting point depressant, does not have as great impact in comparison to e.g. B. So if silicon alone is used as a melting point decreased, a quite large amount has to be used. Silicon may also form suicides, why large amounts may cause problems. One element which can be used as a melting point depressant is phosphorous. Phosphorus could be a good selection if only the brazing temperature was of importance, since it has a great impact on the melting point. However, braze joints with large amounts of P are normally very fragile and have therefore quite low strength. Phosphor can also form phosphides, such as iron-phosphides, that are fragile and decrease the strength of the braze filler and the base material. Surprisingly, when alloying with a new type of mixture comprising Si and P, a new type of iron based braze filler was found, which has a low melting interval without or very low negative effects from the Si and P additives. The alloy also had another surprising positive property—a narrow melting interval, which is very positive when brazing. The reason why is that it is desirable that all elements in the braze filler should melt at approximately the same time. Another positive property is that the filler of the present invention is wetting the surface very well and has great flow ability.

### SUMMARY OF THE INVENTION

The present invention relates to an iron based brazing material comprising an alloy essentially containing 15 to 30 percent by weight, herein after wt %, chromium (Cr), 0 to 5.0 wt % manganese (Mn), 9 to 30 wt % nickel (Ni), 0 to 4.0 wt % molybdenum (Mo), 0 to 1.0 wt % nitrogen (N), 1.0 to 7.0 wt % silicon (Si), 0 to 0.2 wt % boron (B), 1.0 to 7.0 wt % phosphorus (P), optionally 0.0 to 2.5 wt % of each of one or more of elements selected from the group consisting of vanadium (V), titanium (Ti), tungsten (W), aluminum (Al), niobium (Nb), hafnium (Hf) and tantalum (Ta); the alloy being balanced with Fe, and small inevitable amounts of contaminating elements; and wherein Si and P are in amounts effective to lower melting temperature.

According to one alternative aspect of the invention, any one of the elements may be selected from the group consisting of carbon (C), vanadium (V), titanium (Ti), tungsten (W), aluminum (Al), niobium (Nb), hafnium (Hf), and tantalum (Ta) and be in an amount within the range from about 0 to 1.5 wt %.

According to one alternative aspect of the invention, the contaminating elements can be any one of carbon (C), oxygen (O), and sulphur (S). According to another alternative, manganese may be present in the alloy and the amount is within the range of 0.1 to 5.0 wt % manganese. According to another alternative, manganese may be present in the alloy and the amount is within the range of 0.1 to 4.5 wt %. According to a further alternative, the alloy may contain chromium within the range from about 18 to about 26 wt % or nickel within the range of from about 9.0 to about 20 wt % or molybdenum within the range from about 0.5 to about 3.5 wt %, or combinations thereof. According to a further alternative, the alloy may contain nickel within the range from about 9.0 to about 18.0 wt %. According to a further alternative, the alloy may contain silicon within the range from about 2.0 to about 6.0 wt % or boron within the range from about 0 to about 0.1 wt % or phosphorus within the range from about 2.0 to about 6.0 wt %, or combinations thereof.

According to a further alternative, the alloy may contain silicon within the range from about 2.5 to about 6.0 wt % and phosphorus within the range from about 3.5 to about 6.0 wt %.

According to a further alternative, the brazing material may comprise an alloy consisting essentially of: 16 to 18 wt % chromium (Cr); 1.5 to 2.0 wt % manganese (Mn); 11 to 17 wt % nickel (Ni); 1.5 to 2.5 wt % molybdenum (Mo); 0 to 1.0 wt % nitrogen (N); 3.0 to 5.0 wt % silicon (Si); 0 to 0.2 wt % boron (B); 4.0 to 5.5 wt % phosphorus (P); optionally 0.0 to 2.5 wt % of each of one or more of elements selected from the group consisting of vanadium (V), titanium (Ti), tungsten (W), aluminum (Al), niobium (Nb), hafnium (Hf) and tantalum (Ta); the alloy being balanced with Fe, and small inevitable amounts of contaminating elements; and wherein Si and P are in amounts effective to lower melting temperature.

According to further aspects, an iron based brazing material comprises an iron-based alloy consisting essentially: (i) 16 to 21 wt % chromium (Cr); (ii) 0.5 to 2.0 wt % manganese (Mn); (iii) 11 to 17 wt % nickel (Ni); (iv) 0.5 to 2.1 wt % molybdenum (Mo); (v) 0 to 1.0 wt % nitrogen (N); (vi) 3.8 to 5.0 wt % silicon (Si); (vii) 0 to 0.2 wt % boron (B); (viii) 4.8 to 5.3 wt % phosphorous (P); and wherein Si and P are in amounts effective to lower melting temperature. The alloy may have a solidus temperature and a liquidus temperature of 75° C. or less, and the alloy may be produced by at least one of gas-atomising, water-atomising, or melt-spinning.

According to further aspects, a method of brazing articles of stainless steel comprises: providing a brazing material. The brazing material comprises an iron-based alloy consisting essentially of: (i) 16 to 21 wt % chromium (Cr); (ii) 0.5 to 2.0 wt % manganese (Mn); (iii) 11 to 17 wt % nickel (Ni); (iv) 0.5 to 2.1 wt % molybdenum (Mo); (v) 0 to 1.0 wt % nitrogen (N); (vi) 3.8 to 5.0 wt % silicon (Si); (vii) 0 to 0.2 wt % boron (B); (viii) 4.8 to 5.3 wt % phosphorous (P); and wherein Si and P are in amounts effective to lower melting temperature. The method further comprises: (i) applying the brazing material on to parts of stainless steel; (iii) assembling the parts; and (iv) heating the parts from step (ii) or step (iii) in a non-oxidizing atmosphere, in a reducing atmosphere, in vacuum, or combinations thereof, up to a temperature of at least 250° C. for at least 10 minutes, then heating the parts up to a temperature of less than 1080° C. for at least 10 minutes, then heating the parts up to a temperature less than about 1200° C. for at least 5 minutes.

According to further aspects, the parts in step (iv) are heated in a non-oxidizing atmosphere, in a reducing atmosphere, in vacuum, or combinations thereof, up to a temperature of at least 250° C. for at least 10 minutes, then heating the parts up to a temperature of less than 1080° C. for at least 30 minutes, then heating the parts up to a temperature over about 1100° C. for less than 720 minutes and then cooling the parts. A brazed article may be obtained by the foregoing methods, and the article may be a plate heat exchanger.

### BRIEF DESCRIPTION OF THE DRAWING

FIG.1 shows a DSC-curve;

FIG. 2, FIG. 3, FIG. 4, FIG. 5, FIG. 6 and FIG. 7 each show a DSC-TGA diagram for various samples of Example 4, described below.

### DETAILED DESCRIPTION

The alloy may be manufactured by gas-atomising or water-atomising or melt-spinning.

As mentioned above, brazing temperature is preferably below the original solidus temperature of the material of the parts to be brazed. The brazing cycle involves both melting and solidifying of the brazing material. The melting temperature and solidifying temperature may be the same for very specific materials, but the usual situation is that materials are melting within temperature range of melting, and solidifying within another temperature range of solidifying. The temperature range between the solidus state and the liquidus state is herein defined as the temperature difference between the solidus state and the liquidus state, and is measured in ° C. One composition range of the brazing material of the invention has a temperature difference between the solidus state and the liquidus state, which according to one alternative aspect of the invention is 200° C. or less. According to another alternative composition range of the brazing material, the alloy has a difference between solidus temperature and a liquidus temperature of 150° C. or less. According to another alternative composition range of the brazing material, the alloy has a difference between solidus temperature and a liquidus temperature of 100° C. or less. According to another alternative composition range of the brazing material, the alloy has a difference between solidus temperature and a liquidus temperature of 75° C. or less. According to another alternative composition range of the brazing material, the alloy has a difference between solidus temperature and a liquidus temperature of 50° C. or less. According to another alternative composition range of the brazing material, the alloy has a difference between solidus temperature and a liquidus temperature of 45° C. or less.

According to a further alternative aspect of the present invention, the iron-based brazing material may be manufactured as a paste. The iron-based brazing paste of the present invention may comprise the iron-based brazing material and an aqueous binder system or an organic binder system. The binder system may comprise a solvent, which could be hydrophilic or hydrophobic i.e. water-based or oil-based. The oil-based binder could be polymers such as poly (met) acrylate among others, could be biopolymers such as cellulose derivatives, starches, waxes, etc. According to another alternative, the iron-based brazing paste of the invention may comprise the iron-based brazing material and an aqueous binder system or an organic binder system based on a solvent such as water, oils, or combinations thereof. The alloy comprised in the paste may be in the form of powder, granules, etc.

The present invention relates also to a method of brazing articles of stainless steel, comprising the following steps: step (i) applying the brazing material of the invention on to parts of stainless steel; step (ii) optionally assembling the parts; step (iii) heating the parts from step (i) or step (ii) in a non-oxidizing atmosphere, in a reducing atmosphere, in vacuum, or combinations thereof, to a temperature of up to at least 250° C. for at least 10 minutes, then heating the parts up to a temperature of less than 1080° C. for at least 10 minutes, heating the parts up to a temperature less than about 1200° C. for at least 5 minutes and then cooling the parts; and optionally step (iv) repeating one or more of step (i), step (ii) and step (iii). Different brazed products need different brazing procedures; some products could be brazed by just going through step (i), step (ii) and step (iii), but other products are more complicated and one or more of step (i), step (ii) and step (iii) need to be repeated as indicated in step (iv).

According to an alternative of the invention, the method may also comprise that the parts in step (iii) are heated in a non-oxidizing atmosphere, in a reducing atmosphere, in vacuum, or combinations thereof, up to a temperature of at least 250° C. for at least 10 minutes, then heating the parts up to a temperature of less then 1080° C. for at least 30 minutes, then heating the parts up to a temperature over about 1100° C. for less than 720 minutes, and then cooling the parts.

According to one alternative of the invention, heating the parts up to a temperature over about 1100° C. may be for less than 360 minutes before cooling the parts. According to another alternative of the present invention, heating the parts up to a temperature over about 1100° C. may be for less than 180 minutes before cooling the parts.

According to an alternative of the invention, the method may also comprise that the parts in step (iii) are brazed at a temperature within the range of from about 1040° C. to about 1190° C. for less than 30 minutes.

According to another alternative of the invention, the method may also comprise that the parts in step (iii) are brazed at a temperature within the range of from about 1040° C. to about 1190° C. for less than 20 minutes.

According to yet another alternative of the invention, the method may also comprise that the parts in step (iii) are brazed at a temperature within the range of from about 1040° C. to about 1190° C. for at least 1 minute.

According to yet another alternative of the invention, the method may also comprise that the parts in step (iii) are brazed at a temperature within the range of from about 1100° C. to about 1180° C. for at least 1 minute.

According to a further alternative embodiment of the invention, the method may also comprise that the parts in step (iii) are preheated up to a temperature below 1050° C. before heating up to a temperature of above 1100° C. for at least 5 minutes. And then heat treating the parts at a temperature above 950° C. for at least accumulated 20 min, this can be made in the braze cycle, but also after the braze in e.g. at a second heating source.

According to another alternative, the brazing material may be sprayed as a powder on the surfaces, which shall be joined, by for instance a paint spray gun, rolling, brushing, thermal spraying, e.g. high velocity oxygen fuel (HVOF) etc or the surface, joint etc. may be coated by melts.

The iron based brazing filler material may be applied to planar surfaces or to large surfaces by the aid of capillary force breakers. The capillary force breakers can be in the form of grooves, traces, paths, passages, “v” or “u” shaped tracks or pathways etc. or in the form of nets etc. The iron-based brazing filler material may be applied into the capillary force breakers, i.e. into the grooves, traces, paths, passages, “v” or “u” shaped tracks, pathways, nets etc., or the brazing filler material may be applied close to the capillary force breakers. During heating, the applied iron-based brazing filler material will flow to the area where the capillary force may be broken and braze together the surfaces, which are adjacent to each other. Thus, the brazed area provides brazed, sealed or tightcrevices, joints etc. between planar surfaces where it is hard otherwise to braze uniformly. The capillary force breakers enable also brazing of surfaces having large crevices, parts having odd shapes, etc.

When the brazing material is applied between two parts close to a capillary force breaker, the flowing viscous brazing material will stop the flowing motion and set at the rim of the capillary force breaker. A reactor channel may be functioning as a capillary force breaker. A plate having a reactor channel is applied with brazing material and a barrier plate or the like is placed in contact with the reactor channel plate. The flowing brazing material will stop and set at the border of the reactor channel, which will seal the reactor plate against the barrier plate without filling the reactor channel with set brazing material.

How far the brazing material can flow between two bordering surfaces depends partly on the brazing material's setting time and the distance between the surfaces, and the amount of brazing material. Since the brazing material “sticks” to each surface, which is to be brazed, the intermediate space between the surfaces becomes smaller. As the intermediate space becomes smaller while at the same time the brazing material sets, it also becomes more difficult for the brazing material to flow in between. The desired amount of brazing material is supplied to the contact points, which are to be brazed together in any of the described or other ways. The brazing material may cover an area that is somewhat larger than the contact joint point. The contact joint points may have a diameter of at least 0.5 mm. Since the brazing process is a metallic process and the respective surfaces for brazing take the form of metallic material, then iron-based brazing material during the brazing process diffuses with bordering surfaces, which are to be brazed together. The joint or seam between the two joined surfaces will more or less “disappear” during the brazing process according to one aspect of the invention. The brazed seam together with the surfaces of the metallic parts will become a unity with only small changes in material composition of the alloys.

During brazing, the brazing material will migrate by capillary forces to areas to be joined by brazing. The brazing material according to the invention has good wetting ability and good flow ability, which will result that residual alloys around the brazing areas will be small. According to one alternative, the residual alloys after brazing will have a thickness less than 0.1 mm on the applied surfaces.

The present invention relates also to an article of stainless steel obtained by the present method. The present invention relates further to a brazed article of stainless steel, which comprises at least one base material of stainless steel and brazed brazing material of the invention.

According to one alternative aspect, the articles or the parts may be selected from reactors, separators, columns, heat exchangers, or equipments for chemical plants or food plants, or for car-industries. According to another alternative aspect, the objects may be heat exchangers, plate reactors, or combinations thereof. According to another alternative aspect of the invention, the brazed article may be a paring disc, which is used in a separator. According to one alternative aspect, the articles may be brazed heat exchanger plates, brazed reactor plates, or combinations thereof.

When the parts are heat exchanger plates, the plates can be endplates, adaptor plates, sealing plates, frame plates etc., and constitute a heat exchanger system. Each of the heat exchanger plates comprise at least one port recess, which port recesses together form part of a port channel when the plates are placed on one another. The plates are stacked together in a plate stack or a plate pack in the heat exchanger. The plate package comprises between the plates a number of channels, which accommodate a number of media. The media in adjacent channels are subject to temperature transfer through the heat transfer plate in a conventional manner. The plates may comprise an edge, which may partly extend down and over the edge portion of an adjacent heat transfer plate in the plate stack. The edges of the plates seal against the adjacent heat transfer plate in such a way that a channel may be formed between the plates. This channel either allows flow of a medium or is closed so that no flow takes place and the channel is therefore empty. To stiffen the plate package and the port regions, an adaptor plate or an endplate may be fitted to the package. The surfaces of the endplate or the adaptor plate are with may be planar so that contact surfaces between the surfaces may be maximised. As previously mentioned, the respective port recesses on the plates coincide, thereby forming a channel. On the inside of this port channel, there is therefore a joint between the two plates. To prevent leakage at this joint, brazing material may be applied round the port region between the plates. The brazing material may be placed in or close by a capillary force breaker, which may extend wholly or partly round the port region between the plates. In the plate package, brazing material may be applied on different pre-designed or predetermined parts of the plates. During the brazing process, the brazing material will become viscous and will flow from the applied parts out between the plates due to the action of capillary force. The advantage of applying brazing material on to predetermined places makes it possible to control volume and amount of the brazing material, and to control which parts of the surfaces are to be brazed and which are not. When brazing a heat exchanger, at least three heat exchanger plates are needed, but it is usual that several plates are brazed together. According to one alternative aspect of the invention, a plate pack of several plates are brazed together at the same time in the same oven. In one embodiment, the plate heat exchangers includes two or more plates brazed to one another with the brazing material and methods disclosed herein and the plates are manufactured from an austenitic stainless steel such as 316 stainless steel comprising maximum 2.0 wt % Mn, 16.5-18 wt % Cr, 10.0-13.0 wt.% Ni, 2.0-2.5 wt % Mo, balance Fe and inevitable amounts of contaminating elements.

The brazing method of the invention may either comprise brazing the article assembled with all its parts at the same time or the article may be brazed in a stepwise fashion where parts are first assembled and brazed together, and then assembled with further parts and brazed together, and so on using the same type of brazing material in each brazing cycle.

Further developments are specified in independent claims and the dependent claims.

The invention is explained in more detail in the following Examples. The purpose of the Examples is to test the brazing material of the invention, and is not intended to limit the scope of the invention.

### EXAMPLE 1

Test samples 1 to 4 were made for checking the solidus and liquidus temperatures of the brazing material of the invention. The compositions of the test samples are summarised in Table 1.

TABLE 1

| Sample | Fe | Cr | Mn | Ni | Mo | Si | P | C | B |
|---|---|---|---|---|---|---|---|---|---|
| No. | [wt %] | [wt %] | [wt %] | [wt %] | [wt %] | [wt %] | [wt %] | [wt %] | [wt %] |
| 1 | bal. | 16.48 | 1.63 | 16.65 | 2.02 | 4.57 | 4.9 | 0.016 | .01 |
| 2 | bal. | 17.37 | 1.9 | 11.99 | 2.13 | 4.91 | 5.19 | 0.014 | .01 |
| 3 | bal. | 17.42 | 1.67 | 13.33 | 1.99 | 3.69 | 5.0 | 0.013 | .01 |
| 4 | bal. | 16.63 | 1.82 | 15.99 | 1.89 | 3.3 | 4.69 | 0.018 | .01 |

The liquidus and solidus temperature of the samples was tested by means of differential thermal analysis (DTA). The atmosphere used when analysing was Argon. The test was performed with a heating and cooling rate of 10° C./min. The liquidus temperature is the temperature above which a substance is completely liquid. The solidus temperature is the temperature below which a substance is completely solid. The values for the solidus and liquidus temperature were established by estimations where the melting process started and stopped.

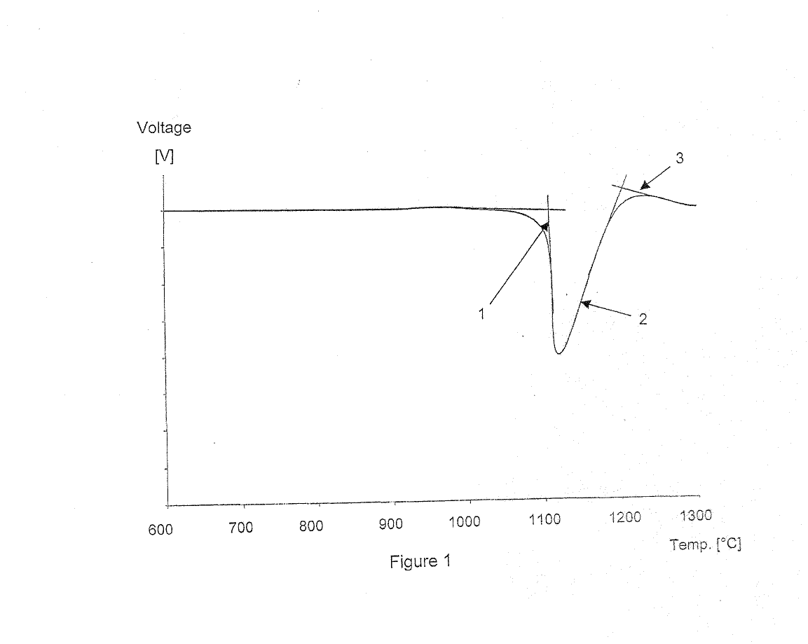

The estimations were performed by approximation of the melting curve, which was measured and registered as a DTA-curve, see FIG. 1. The melting process can be seen in the DTA-curve by the change in the gradient of the heating curve. When the process is finalised, the gradient becomes constant again. To establish the start and stop of the melting process, an approximation was made by drawing tangents (1) on the voltage drop peak (2). Tangents (3) on the base line are drawn and where the tangents (1) and (3) are crossing each other, there are the approximated end values of the melting range.

The solidus temperatures and the liquidus temperatures of each sample are calculated as described above and are summarised in Table 2.

TABLE 2

| | Solidus temp. | Liquidus temp. | Difference |
|---|---|---|---|
| Sample No. | [° C.] | [° C.] | [° C.] |
| 1 | 1058 | 1097 | 39 |
| 2 | 1068 | 1099 | 31 |
| 3 | 1055 | 1100 | 45 |
| 4 | 1060 | 1092 | 32 |

The tests show that the difference between solidus temperature and liquidus temperatures are surprisingly narrow.

### EXAMPLE 2

Test samples 5 to 8 were made for checking tensile strength of joints having brazed zones of the brazing material of the invention. The compositions of the test samples of unbrazed brazing material are summarised in Table 3.

TABLE 3

| Sample | Fe | Cr | Mn | Ni | Mo | Si | P | |
|---|---|---|---|---|---|---|---|---|
| No. | [wt %] | [wt %] | [wt %] | [wt %] | [wt %] | [wt %] | [wt %] | C [wt %] |
| 5 | bal. | 17.0 | 1.78 | 12.1 | 2.13 | 1.01 | 10.1 | 0.067 |
| 6 | bal. | 17.0 | 1.53 | 12.1 | 2.35 | 0.44 | 10.8 | 0.045 |
| 7 | bal. | 17.4 | 1.79 | 12.0 | 2.32 | 4.44 | 5.78 | 0.12 |
| 8 | bal. | 17.3 | 1.76 | 12.1 | 2.31 | 5.55 | 5.89 | 0.111 |

The brazing materials were tested by means of making braze trials of small pressed plates. The brazed samples were then tensile tested, the results are summarised in Table 4.

TABLE 4

| | Braze cycle for at least 15 min. | |
|---|---|---|
| Sample No. | at [° C.] | Waffle test [kN] |
| 5 | 1120 | 2.1 |
| 6 | 1120 | 2.4 |
| 7 | 1190 | 3.0 |
| 8 | 1190 | 2.7 |

As can be seen from Table 4, the tensile test results on samples brazed with braze materials having small amounts of Si, i.e. less than 1.2 wt %, and large amounts of phosphorus, see samples number 5 and 6, had a much lower strength than those brazed with a brazing material having higher amounts of Si, see samples 7 and 8. Both Example 1 and Example 2 show surprisingly that when decreasing the amount of P and increasing the amount of Si result in increase of the tensile strength as well as lower the melting temperature, and small temperature melting intervals was found.

### EXAMPLE 3

Test samples of braze filler materials were compared in this Example for the purpose of checking performances on brazed prototypes. Test prototypes were brazed with different test sample of the braze fillers. The prototypes used in these tests were brazed plate heat exchangers. All prototypes were manufactured with the identical parts, such as identical plates, connections, reinforcements etc. Everything was done with the purpose to make the prototypes as identical as possible. The only difference between the prototypes were the braze filler and the braze cycles. The differences in braze cycle were of course necessary, since different braze fillers have different braze cycles. Three different braze fillers were used—filler A was a pure copper (Cu) braze filler, fillers B and C (according to the invention) are listed in Table 5 below. The inevitable amounts of contaminating elements are not listed in the Table.

TABLE 5

| | Fe | Cr | | Ni | Mo | Si | P | B |
|---|---|---|---|---|---|---|---|---|
| Filler | [wt %] | [wt %] | Mn [wt %] | [wt %] | [wt %] | [wt %] | [wt %] | [wt %] |
| B | Bal. | 17.1 | 1.3 | 14.5 | 1.8 | 9.5 | — | 0.9 |
| C | Bal. | 17.3 | 1.9 | 11.9 | 2.1 | 4.9 | 5.1 | — |

The brazed heat exchangers prototypes were then evaluated by testing their burst pressure, pressure fatigue, and temperature fatigue. The burst pressure test was carried out by increasing the pressure until failure, the pressure fatigue test was carried out by alternating the pressure with a set pressure variation until failure, and the temperature fatigue test was carried out by alternating the temperature with a set temperature variation and temperature heating/cooling rate until failure. The results of the tests are summarised in Table 6.

TABLE 6

| Test | Filler A | Filler B | Filler C |
|---|---|---|---|
| Burst pressure | 197 | 111 | 91 |
| [bar] | | | |
| Burst pressure | 183 | 106 | 92 |
| [bar] | | | |
| Burst pressure | 189 | 103 | 97 |
| [bar] | | | |
| Pressure fatigue | 88 | 91 | 154 |
| (1000 cycles) | | | |
| Pressure fatigue | 67 | 101 | 207 |
| (1000 cycles) | | | |
| Pressure fatigue | 119 | 119 | — |
| (1000 cycles) | | | |
| Temperature fatigue | 913 | 991 | 1704 |
| [cycles] | | | |
| Temperature fatigue | 1037 | 985 | 1442 |
| [cycles] | | | |
| Temperature fatigue | 1011 | 988 | 1573 |
| [cycles] | | | |

The results of the burst pressure tests indicate that filler C has the lowest mechanical properties. The tests showed that the temperature fatigue performances were highest for filler C, and also that the pressure fatigue performances were highest. The results were very surprising since it was not expected that both the temperature- and the pressure fatigue performances could be highest for the new filler, since filler C had the lowest burst pressure of the three.

One of the reasons for the exceptional good fatigue results is the combination of the braze fillers properties. For example, the new braze filler of the invention has excellent wetting and flow properties, which properties result in smooth braze joints that distribute the load evenly in the brazed joint and decrease the risk for initiation of fatigue cracks. The good wetting and flow properties of the filler also result in large brazed joints that will decrease the total stress by increasing the loaded area.

The good flow and wetting properties of the filler were also confirmed by metallographic analysis. Some of the prototypes were cross-sectioned, grind and policed after brazing, with the purpose to study the microstructure etc. It was then observed that the flow and wetting properties were very good, seen that very little residuals of the braze filler was left on the surfaces around the braze joint. Almost all filler had flown to the braze joint by capillary forces. The study confirmed that almost no residuals of the braze filler were left on the base material surface, but almost all were found in the braze joint. Of course there is braze filler on the base material surface close to the braze joint since the braze joint will adapt its shape according to the wetting angle between the braze filler and the base material, consequently this filler is defined to the braze joint also.

The residuals of braze filler on the surface was measured. Measurements of residuals of braze fillers were performed on areas where more than a 0.2 mm thick layer of braze filler had been applied prior to brazing. The cross-sections were studied after brazing with the braze filler. The test result showed that the thickness of the residuals were 0.01, 0.03, <0.01,0.02, <0.01, 0.02, <0.01 mm. These measurements showed the thickness of the residuals are much less than the expected based on other tested iron based braze fillers, which iron based braze filler could have a residual thickness about 0.15 mm. Other areas that differ from these measurements are where the fillers did not have any capillary contact during brazing or due to that the capillaries already were filled with braze filler.

### EXAMPLE 4

Additional testing with six Fe based braze fillers were conducted. The fillers were made by blending different amounts of braze filler A and B with different amounts of NiCrFe, MnP, FeP and/or Ni.

Used Powders:

Filler A and B were braze alloys made by gas atomization. The NiCrFe power, 06604, was from Alfa Aesar (Nickel Chromium Iron Powder, −325 Mech, LOT:A22L26), 250 g. The FeSi powder, 14019, was from Alfa Aesar (Iron silicide, 99.9% metal basis −20 Mech, LOT:K07Q047, 100 g. The MnP powder, 14020, was from Alfa Aesar (Manganese phosphide, 99% (metal basis −100 Mech, Powder, Mn3P2, a mixture of MnP & Mn2P LOT: A28K01), 10 g. The Ni powder, 04321, was bought from Alfa Aesar (Nickel powder, −325 mesh, typically 99.8% (metal basis).

TABLE 7
Composition in weight percent [wt %] for the powders:

| | Fe | Cr | | Ni | | Si | |
|---|---|---|---|---|---|---|---|
| Powder | [wt %] | [wt %] | Mn [wt %] | [wt %] | Mo [wt %] | [wt %] | P [wt %] |
| Filler A | 53.75 | 16.48 | 1.63 | 16.65 | 2.02 | 4.57 | 4.9 |
| Filler B | 57 | 29 | 0.36 | | | 4.61 | 5.9 |
| NiCrFe | 10 | 17.6 | | 72 | | | |
| MnP | | | 72.65 | | | | 27.35 |
| FeSi | 66.5 | | | | | 33.47 | |
| Ni | | | | 100 | | | |

Blends:
Sample 1A: 10.0026 g of filler A+0.106 g of NiCrFe, 0.06 g of MnP and 0.1487 g of FeSi;
Sample 2A: 10.0637 g of filler A+0.052 g of MnP;
Sample 3A: 10.0203 g of filler A+0.1365 of FeSi;
Smple 1B: 3.3 g of filler A+3.3 g of filler B+0.825 g of Ni;
Sample 2B: 2.65 g of filler A+5.2 g of filler B+0.6625 g of Ni; and
Sample 3B: 6.2 g of filler A+3.1 g of filler B.

TABLE 8
Composition of blends/fillers:

| Sample | Fe | Cr | | Ni | | Si | |
|---|---|---|---|---|---|---|---|
| No. | [wt %] | [wt %] | Mn [wt %] | [wt %] | Mo [wt %] | [wt %] | P [wt %] |
| Sample | 53.17 | 16.16 | 2.00 | 16.88 | 1.96 | 4.91 | 4.91 |
| 1A | | | | | | | |
| Sample | 53.47 | 16.40 | 2.00 | 16.56 | 2.01 | 4.55 | 5.02 |
| 2A | | | | | | | |
| Sample | 53.92 | 16.26 | 1.61 | 16.43 | 1.99 | 4.96 | 4.81 |
| 3A | | | | | | | |
| Sample | 50.1 | 20.5 | 0.9 | 18.8 | 0.9 | 3.9 | 4.9 |
| 1B | | | | | | | |
| Sample | 52.9 | 23.4 | 0.7 | 13.1 | 0.6 | 4.0 | 5.2 |
| 2B | | | | | | | |
| Sample | 54.9 | 20.7 | 1.2 | 11.1 | 1.3 | 4.4 | 5.2 |
| 3B | | | | | | | |

### Performed Tests:

The first test was a wetting test. One test for each braze filler was made. For every test 2.0 g of the braze filler was applied on a 0.8 mm plate made of stainless steel type 316. The filler was applied on the center of the test plate on. The filler was applied on an area with a diameter between 13.5-14.00 mm (corresponding to an area of 132-152 mm²). The samples were brazed at app 1140° C. for approximately 1 h in a vacuum furnace. After the braze cycle the wetted area was measured in Light Optical Microscope. Sample 1, 2 and 3 was tested in the wetting test.

The second test was a simultaneous DSC (Differential Scanning Calorimetry) and TGA (Thermal Gravimetric Analysis) of the braze fillers. The test were run in scrubbed* (*using an oxygen filler) argon, with a flow rate of 200 ml/min. The samples were heated to approximately 1260° C., then cooled to approximately 50° C., the heated again to 1260° C. then cooled to room temperature. The heating and cooling speed was 10° C./minute. The thermal analysis reveals the melting range for an alloy, in this case the brazing alloy. By studying the curves from the thermal analysis it is possible to obtain the results. Since the tested sample was a blend, the most representative results from the analysis was the second heating run, since then the fillers already was melted to an alloy in the first heating run. Sample 1 and sample 2 were tested by DSC-TGA.

Results from the First Test (Wetting Test)

Ocular inspection of the three samples showed that all samples had melted and wetted a large area. It was hard to evaluate exactly how large area that was wetted, due to that a very thin phases had flown from the filler. The thin phase was ignored when measuring the filler wetted area.

TABLE 9

| | Wetted area |
|---|---|
| Sample No | [mm²] |
| Sample 1A | 1092 |
| Sample 2A | 1174 |
| Sample 3A | 803 |
| Sample 1B | 1463 |
| Sample 2B | 1012 |
| Sample 3B | 1085 |

Results from the second test (the thermal analysis test-DSC-TGA), values from the two heating cycles from each test

It is noted that the way of estimating the liquidus and solidus temperature has been described above and the same estimation was employed in this Example, as well.

The estimates were performed by approximation of the melting curve, which was measured and registered as a DSC-curve, see FIG. 1. The melting process can be seen in the DSC-curve by the change in the gradient of the heating curve. When the process is finalized, the gradient becomes constant again. To establish the start and stop of the melting process an approximation was made by drawing tangents (1) on the voltage drop peak (2). Tangent (3) on the base line is drawn and where the tangents (1) and (3) are crossing each other there are the approximated end values of the melting range.

TABLE 10

| Sample | | Liquidus |
|---|---|---|
| (DSC-TGA | Solidus temperature (° C.) | temperature (° C.) |
| diagram) | First run/second run | First run/second run |
| Sample 1A | (1010-1044)/1044 | 1092/1083 |
| (Prov Sheet 1) | | |
| Sample 2A | (1100-1045)/1045 | 1087/1085 |
| (Sample 3638 - | | |
| scrubbed Ar) | | |

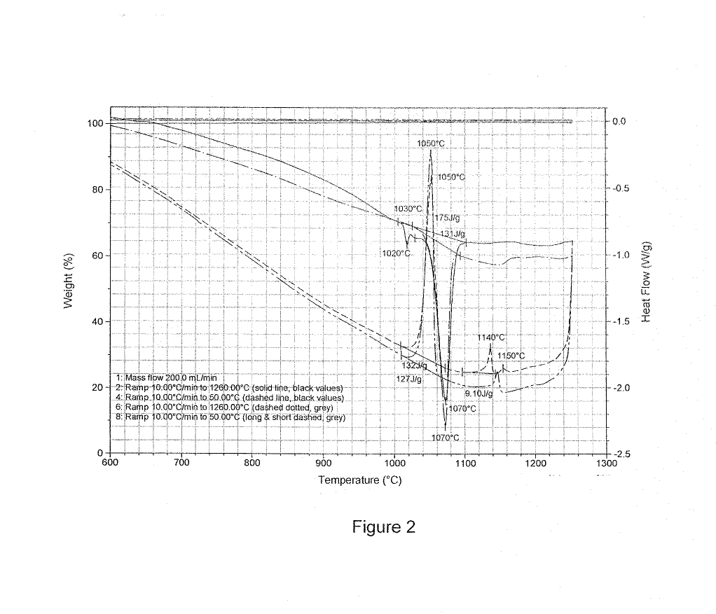

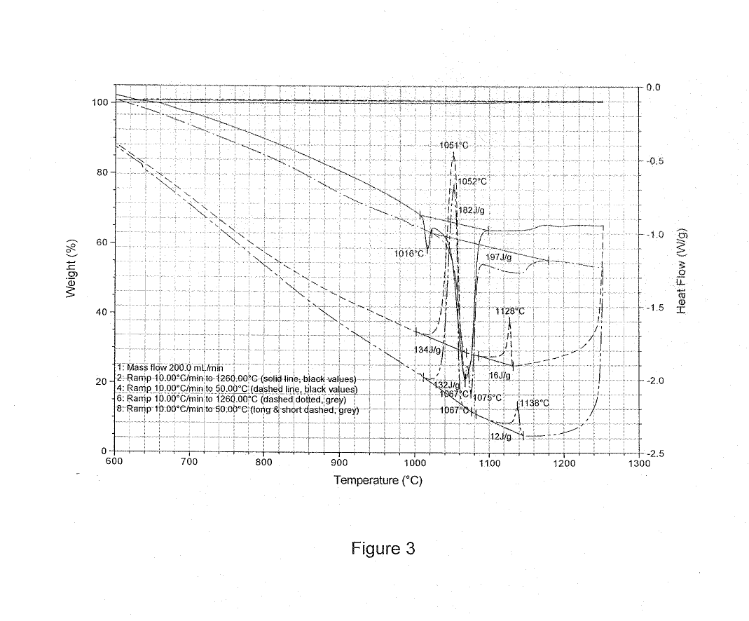

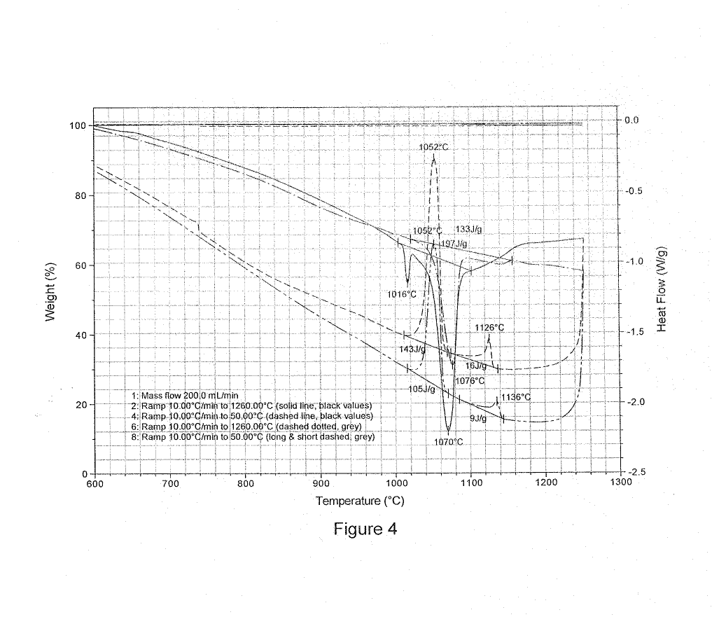

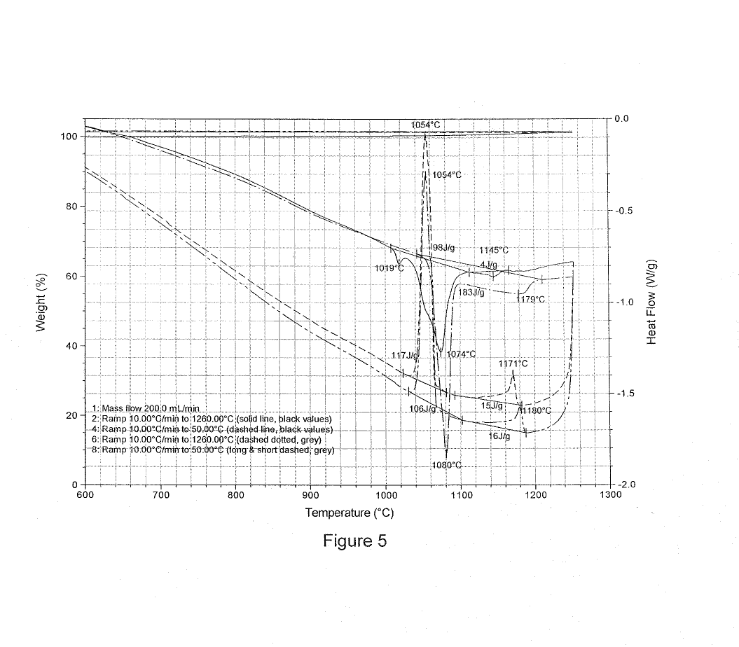

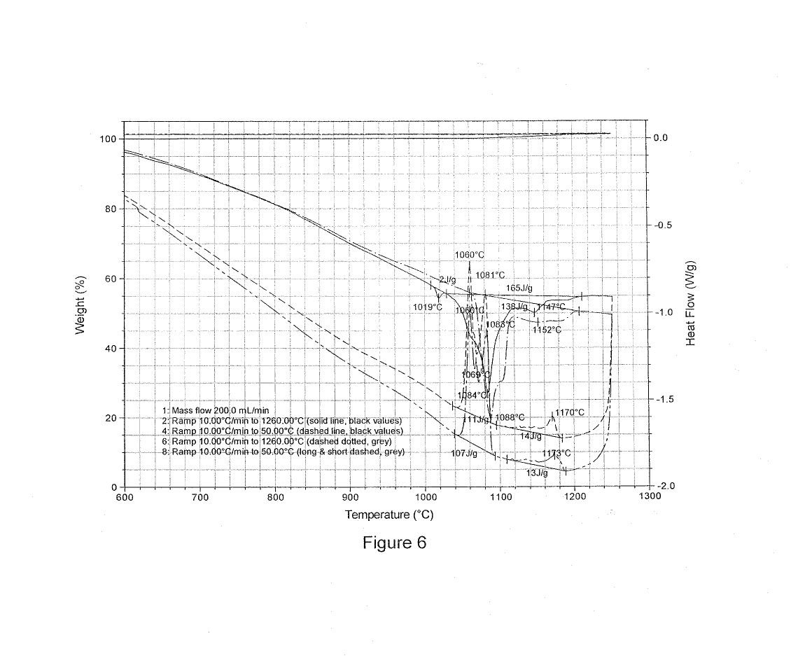

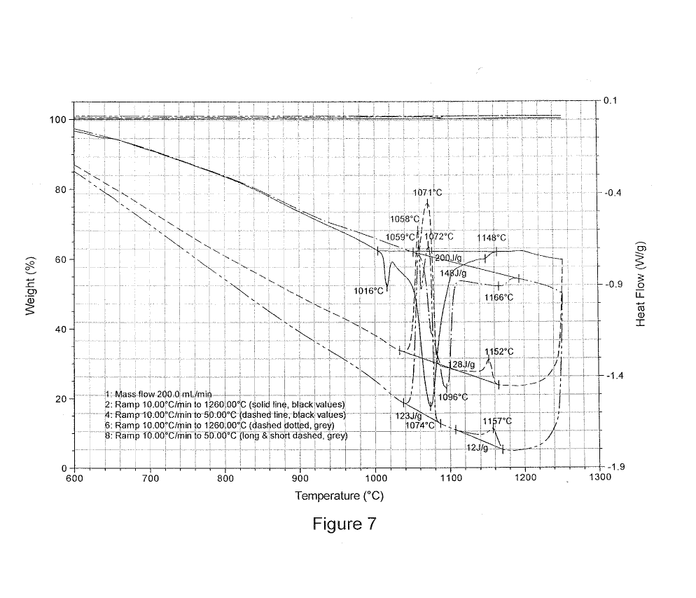

Melting range sample 1A: 1044-1083° C. (See also FIG. 2), and for sample 2A: 1045-1085° C. (See also FIG. 3)

TABLE 11

| Sample | | |
|---|---|---|
| (name in DSC-TGA | Solidus temperature | Liquidus temperature |
| diagram) | Second run (° C.) | Second run (° C.) |
| Sample 1B | 1058 | 1088 |
| Sample 2B | 1068 | 1113 |
| scrubbed Ar) | | |
| Sample 3B | 1064 | 1109 |

Melting range sample 1B: 1058-1088° C., for sample 2B: 1068-1113° C. (See also FIG. 4) and for sample 3B 1064-1109° C.

Thus, it can be seen that all compositions according to samples 1A to 3A and samples 1B to 3B worked as brazed fillers and wetted the stainless steel sample. The wetted area was more than five (5) times larger than the applied area of the braze filler of sample 1 to 3. See also FIGS. 5-7 for DSC-TGA analysis graphs for samples 1 to 3, respectively. The DSC-TGA analysis for the second run, when an alloy is measured, showed that the melting range was approximately 40° C. for analyzed samples (1A, 2A, 1B, 2B, 3B).

It is noted that the terms “a” and “an” and “the” herein do not denote a limitation of quantity, and are to be construed to cover both the singular and the plural, unless otherwise indicated herein or clearly contradicted by context. Any use of the suffix “(s)” herein is intended to include both the singular and the plural of the term that it modifies, thereby including one or more of that term. Reference in the specification to “one embodiment”, “another embodiment”, “an embodiment”, and so forth, means that a particular element (e.g., feature, structure and/or characteristic) described in connection with the embodiment is included in at least one embodiment described herein, and may or may not be present in other embodiments. In addition, it is to be understood that the described elements may be combined in any suitable manner in the various embodiments. Moreover, regarding the Drawings, it is noted that the Drawings herein are merely representative of examples of embodiments and features thereof, and are thus not intended to be limiting or be of exact scale.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1-36. (canceled)

37. An iron based brazing material comprising an iron-based alloy consisting essentially of:
(i) 16 to 21 wt % chromium (Cr);
(ii) 0.5 to 2.0 wt % manganese (Mn);
(iii) 11 to 17 wt % nickel (Ni);
(iv) 0.5 to 2.1 wt % molybdenum (Mo);
(v) 0 to 1.0 wt % nitrogen (N);
(vi) 3.8 to 5.0 wt % silicon (Si);
(vii) 0 to 0.2 wt % boron (B);
(viii) 4.8 to 5.3 wt % phosphorous (P);
and wherein Si and P are in amounts effective to lower melting temperature.

38. An iron based brazing material according to claim 37, further comprising 0.0 to 2.5 wt % of each of one or more of elements selected from the group consisting of vanadium (V), titanium (Ti), tungsten (W), aluminum (Al), niobium (Nb), hafniumm (Hf) and tantalum (Ta); the alloy being balanced with Fe, and small inevitable amounts of contaminating elements.

39. The brazing material according to claim 38, wherein the contaminating elements are any one of carbon (C), oxygen (O), and sulphur (S).

40. The brazing material according to claim 37, wherein the alloy has a difference between a solidus temperature and a liquidus temperature of 75° C. or less.

41. The brazing material according to claim 37, wherein the alloy is produced by at least one of gas-atomising, water-atomising, or melt-spinning.

42. A method of brazing articles of stainless steel, comprising the following steps:
(i) providing a brazing material comprising an iron-based alloy consisting essentially of:
(i) 16 to 21 wt % chromium (Cr);
(ii) 0.5 to 2.0 wt % manganese (Mn);
(iii) 11 to 17 wt % nickel (Ni);
(iv) 0.5 to 2.1 wt % molybdenum (Mo);
(v) 0 to 1.0 wt % nitrogen (N);
(vi) 3.8 to 5.0 wt % silicon (Si);
(vii) 0 to 0.2 wt % boron (B);
(viii) 4.8 to 5.3 wt % phosphorous (P);
and wherein Si and P are in amounts effective to lower melting temperature;
(ii) applying the brazing material on to parts of stainless steel;
(iii) assembling the parts; and
(iv) heating the parts from step (ii) or step (iii) in a non-oxidizing atmosphere, in a reducing atmosphere, in vacuum, or combinations thereof, up to a temperature of at least 250° C. for at least 10 minutes, then heating the parts up to a temperature of less than 1080° C. for at least 10 minutes, then heating the parts up to a temperature less than about 1200° C. for at least 5 minutes.

43. The method of brazing according to claim 42, wherein the parts in step (iv) are heated in a non-oxidizing atmosphere, in a reducing atmosphere, in vacuum, or combinations thereof, up to a temperature of at least 250° C. for at least 10 minutes, then heating the parts up to a temperature of less than 1080° C. for at least 30 minutes, then heating the parts up to a temperature over about 1100° C. for less than 720 minutes and then cooling the parts.

44. A brazed article obtained by the method according to claim 42.

45. The brazed article according to claim 44, wherein the article is a plate heat exchanger.

46. The brazed article according to claim 45, wherein the plate heat exhanger comprises at least two plates brazed to one another with the brazing material and wherein the at least two plates are 316 stainless steel comprising maximum 2.0 wt % Mn, 16.5-18 wt % Cr, 10.0-13.0 wt.% Ni, 2.0-2.5 wt % Mo, balance Fe and inevitable amounts of contaminating elements

47. An iron based brazing material for brazing stainless steel comprising an iron-based alloy consisting essentially of:
16.48 to 17.42 wt % chromium (Cr);
1.63 to 1.9 wt % manganese (Mn);
99 to 16.65 wt % nickel (Ni);
1.89 to 2.13 wt % molybdenum (Mo);
0 to 1.0 wt % nitrogen (N);
0.3 to 4.91 wt % silicon (Si);
0 to 0.2 wt % boron (B);
69 to 5.19 wt % phosphorous (P);
optionally 0.0 to 2.5 wt % of each of one or more of elements selected from the group consisting of vanadium (V), titanium (Ti), tungsten (W), aluminum (Al), niobium (Nb), hafnium (Hf) and tantalum (Ta);
the alloy being balanced with Fe, and small inevitable amounts of contaminating elements, wherein the contaminating elements are any one of carbon (C), oxygen (O), and sulfur (S);
wherein Si and P are in amounts effective to lower melting temperature; and
wherein the brazing alloy has a difference between solidus temperature and liquidus temperature of 45° C. or less, and the brazing alloy has flow and wetting properties for migration of the brazing alloy by capillary forces to contact points to be brazed.
